(19) United States
(12) Patent Application Publication
(10) Pub. No.: US 2026/0218552 A1
(43) Pub. Date: Jul. 30, 2026

(54) FRICTION HINGE MODULE HAVING A TORQUE ELEMENT AND METHOD FOR RETAINING THE TORQUE ELEMENT

(71) Applicant: Southco, Inc., Concordville, PA (US)

(72) Inventor: Glenn Eric Anderson, Concordville, PA (US)

(73) Assignee: Southco, Inc., Concordville, PA (US)

(21) Appl. No.: 19/145,407

(22) PCT Filed: Dec. 28, 2023
(86) PCT No.: PCT/US2023/086154

§ 371 Date: Jul. 2, 2025

Related U.S. Application Data
(60) Provisional application No. 63/437,551, filed on Jan. 6, 2023.

(51) Int. Cl. E05D 11/08; E05D 11/02; G06F 1/16

(52) U.S. Cl. CPC E05D 11/082; E05D 11/02; G06F 1/1681; E05Y 2201/26

(57) ABSTRACT

A hinge module for coupling components for pivotal movement relative to one another is provided. The hinge module includes a shaft defining a pivot axis and a torque element frictionally engaging the shaft. The hinge module comprises a shaft defining a pivot axis and a torque element frictionally engaging the shaft. The hinge module also includes a housing defining a slot configured to at least partially receive a base portion of the torque element. The slot defines internal contact surfaces including ridges positioned for contact between the housing and the base portion of the torque element and grooves interposed between the ridges and extending parallel to the pivot axis. The ridges and the grooves each define respective draft angles, with the draft angle of the ridges being less than the draft angle of the grooves.

### CROSS-REFERENCE TO RELATED APPLICATION

This application claims priority to U.S. Provisional Application No. 63/437,551, filed Jan. 6, 2023, the contents of which are incorporated herein by reference in their entirety for all purposes.

### FIELD

The present invention relates generally to friction hinge modules that can be used to pivotally connect components in a system, and more specifically to a friction hinge module having a torque element and methods of retaining the torque element within the friction hinge module.

### BACKGROUND

Various types of mechanical hinges are available to connect components in a pivoting relationship. A friction hinge, also referred to as a “constant torque hinge” or “position hinge,” is one type of hinge used on apparatuses that feature a pivoting door, panel or other part that opens and closes about a pivot axis. Friction hinges are commonly used to connect laptop computer screens to keyboards, to connect arm rests to center consoles in automobiles, and to connect smaller web-cams and consumer electronics to portable computer screens, LCD displays, point-of-sale terminals, medical equipment and larger enclosure panels, among other applications.

In a typical friction hinge, a pivot shaft has an outer surface that bears against the inner surface of another part, creating mechanical interference in the hinge. This mechanical interference holds components in a stable position after they are pivoted and released, which is desirable for holding components such as doors and arm rests in any position. The mechanical interference also adds a tactile “quality feel” to the door and arm rest movement, providing substantially constant resistance to rotation engaging the user experience during the closing and opening efforts.

### SUMMARY OF THE INVENTION

The drawbacks of conventional friction hinge assemblies are addressed in many respects by hinge modules and systems in accordance with the invention.

In a first aspect of the invention, a hinge module for coupling components for pivotal movement relative to one another is provided. The hinge module comprises a shaft defining a pivot axis and a torque element frictionally engaging the shaft. The hinge module also includes a housing defining a slot configured to at least partially receive a base portion of the torque element. The slot defines internal contact surfaces including ridges positioned for contact between the housing and the base portion of the torque element and grooves interposed between the ridges and extending parallel to the pivot axis. The ridges and the grooves each define respective draft angles, with the draft angle of the ridges being less than the draft angle of the grooves.

In a second aspect of the invention, a hinge module for coupling a first component to a second component for pivotal movement relative to one another is provided. The hinge module includes a torque element comprising a base and a curved arm extending from the base. The curved arm has an outer diameter and an inner diameter. The inner diameter comprises at least two notches positioned relative to each other, thereby defining a first axis extending upwardly relative to a center of the inner diameter and through the first notch and a second axis extending laterally relative to the center of the inner diameter and through the second notch. The first axis is angled 90 degrees relative to the second axis. A maximum thickness between the inner diameter and the outer diameter is taken along a direction between the first axis and the second axis, with the direction being angled 45 degrees relative to the first axis or second axis.

In another aspect of the invention, a hinge module is provided for coupling components for pivotal movement relative to one another, the hinge module including a shaft defining a pivot axis; a torque element frictionally engaging the shaft, the torque element comprising a base portion; and a housing defining a slot configured to at least partially receive the base portion of the torque element. The slot defines internal contact surfaces including ridges positioned for contact between the housing and the base portion of the torque element and grooves interposed between the ridges and extending parallel to the pivot axis, and the ridges and the grooves each define respective draft angles, the draft angle of the ridges being less than the draft angle of the grooves.

### BRIEF DESCRIPTION OF THE DRAWINGS

The foregoing summary and the following description will be better appreciated and understood in conjunction with the non-limiting examples illustrated in the attached drawing figures, of which:

FIGS. 1A-1E depict views of a hinge module in accordance with an exemplary embodiment of the invention, showing a first indicia;

FIG. 1F is a cross section view of the hinge module of FIG. 1E taken through line 1F-1F;

FIG. 2 depicts an exploded view of the hinge module of FIG. 1A;

FIGS. 3A-3E depict views of a hinge module in accordance with an exemplary embodiment of the invention, showing a second indicia;

FIG. 3F is a cross section view of the hinge module of FIG. 3E taken through line 3F-3F;

FIG. 4 depicts an exploded view of the hinge module of FIG. 3A;

FIGS. 5A-5E depict views of an end cap, in accordance with an exemplary embodiment of the invention;

FIGS. 6A-6D depict views of a housing, in accordance with an exemplary embodiment of the invention;

FIG. 6E is a cross section view of the housing of FIG. 6C taken through line 6E-6E;

FIG. 6F is a cross section view of the housing of FIG. 6C taken through line 6F-6F;

FIG. 6G is a cross section view of the housing of FIG. 6D taken through line 6G-6G;

FIG. 6H is a cross section view of the housing of FIG. 6D taken through line 6H-6H;

FIG. 6I is a detailed view of a portion of the housing of FIG. 6F;

FIG. 6J is a cross section view of the housing of FIG. 6D taken through line 6J-6J;

FIG. 6K is a detailed view of a portion of the housing of FIG. 6D;

FIGS. 7A-7F depict views of an adapter, in accordance with an exemplary embodiment of the invention;

FIGS. 8A-8D depict views of another torque element, in accordance with another exemplary embodiment of the invention;

FIGS. 9A-9C depict views of a shaft, in accordance with an exemplary embodiment of the invention;

FIGS. 10A-10E depict views of exemplary contact surfaces between the housing and the torque element when the hinge module is assembled, in accordance with an exemplary embodiment of the invention;

FIG. 11 (this figure number is intentionally skipped);

FIG. 12 depicts a view of the assembled hinge module, showing the torque element frictionally engaging the shaft and secured within the housing, in accordance with an exemplary embodiment of the invention;

FIG. 13 depicts a view of the assembled hinge module, showing the torque element frictionally engaging the shaft and secured within the housing, in accordance with an exemplary embodiment of the invention;

FIG. 14 depicts a view of a torque element, in accordance with an exemplary embodiment of the invention;

FIGS. 15A-15D depicts views of a torque element, in accordance with another exemplary embodiment of the invention;

FIGS. 16A-16D depict views of an embodiment of a housing for receiving the torque element of FIGS. 15A-15D;

FIG. 16E is a cross section view of the housing of FIG. 16C taken through line 16E-16E;

FIG. 16F is a cross section view of the housing of FIG. 16D taken through line 16F-16F;

FIG. 16G is a cross section view of the housing of FIG. 16C taken through line 16G-16G;

FIG. 16H is a cross section view of the housing of FIG. 16D taken through line 16H-16H;

FIG. 16I is a front view of the housing of FIG. 16A;

FIG. 16J is a cross section view of the housing of FIG. 16I taken through line 16J-16J; and

FIG. 16K is a detailed view of a portion of the housing of FIG. 16G.

### DETAILED DESCRIPTION

Although the invention is illustrated and described herein with reference to specific embodiments, the invention is not intended to be limited to the details shown. Rather, various modifications may be made in the details within the scope and range of equivalents of the claims and without departing from the invention.

Additionally, various forms and embodiments of the invention are illustrated in the figures. It will be appreciated that the combination and arrangement of some or all features of any of the embodiments with other embodiments is specifically contemplated herein. Accordingly, this detailed disclosure expressly includes the specific embodiments illustrated herein, combinations and sub-combinations of features of the illustrated embodiments, and variations of the illustrated embodiments.

Hinges, such as those disclosed herein, are manufactured as a large assembly of parts. The assembly includes some press-in or stamped pieces that are designed for installation into a housing, e.g. symmetric torque elements. In addition, assembly parts of friction hinges may require a housing crimp operation or a coil or solid pin to secure the assembly parts, e.g. secure torque elements within the housing. For example, torque elements may have contact between a spring pin, solid pin, etc. and a leg or base of the torque element. They may also control inside and outside radii to manage stress from torque in both directions.

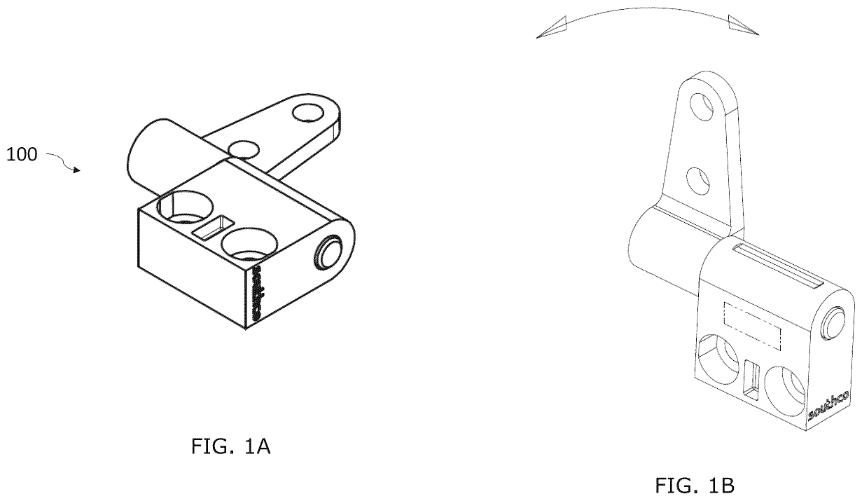

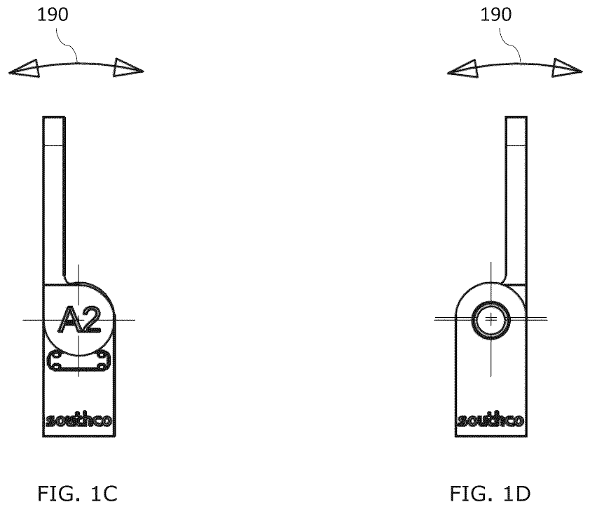

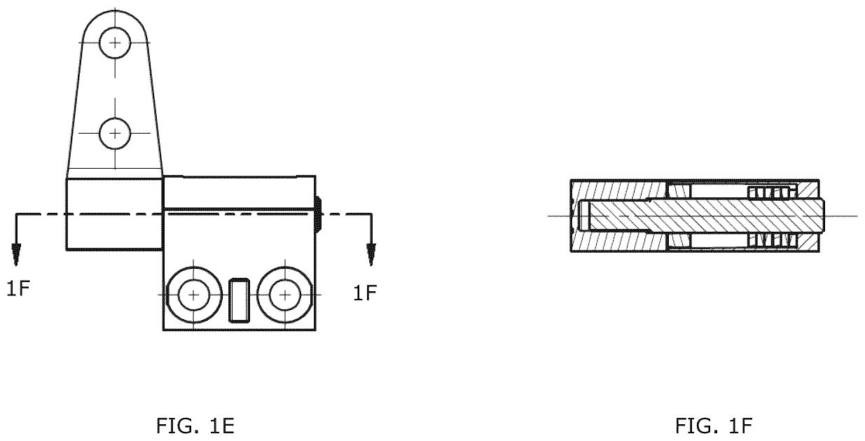

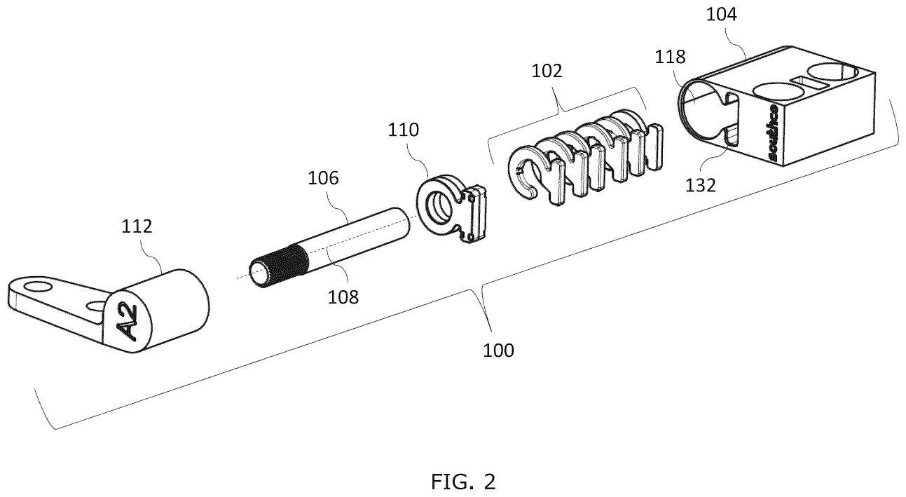

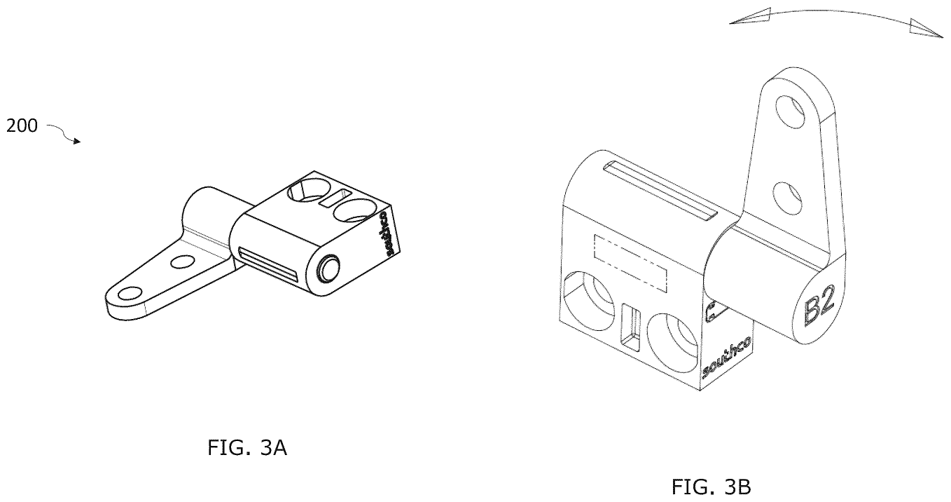

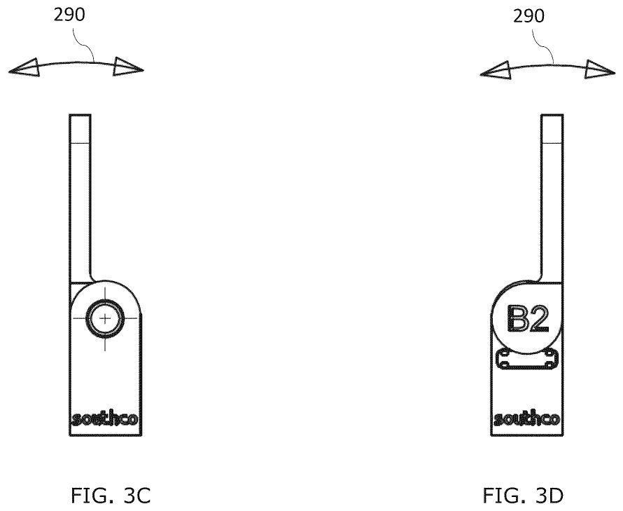

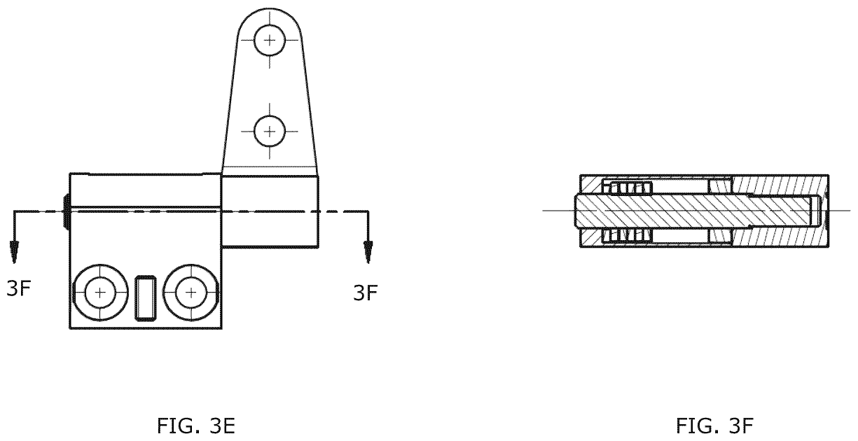

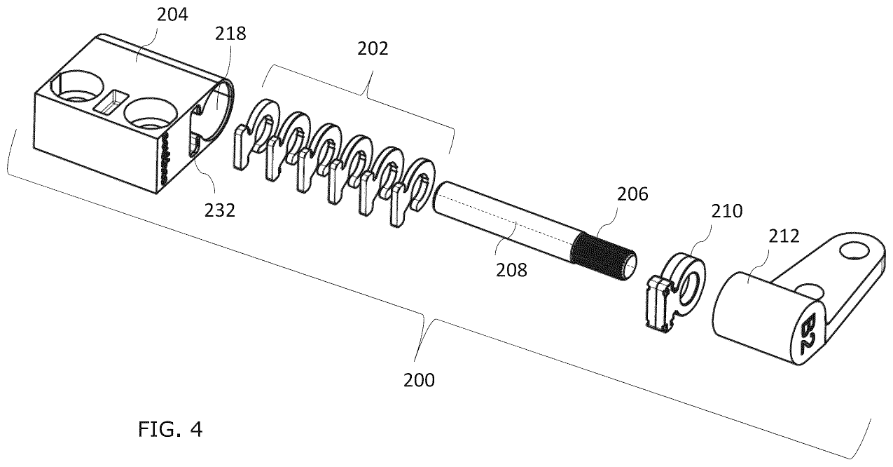

Referring generally to FIGS. 1A-9C, a first hinge module 100 (FIGS. 1A-2) is provided for coupling a first component to a second component for pivotal movement relative to one another. A second hinge module 200 (FIGS. 3A-4), which is substantially similar to the details of hinge module 100 (discussed further below), may also be provided for coupling the first component to the second component for pivotal movement relative to one another.

In an exemplary embodiment, a hinge module set is configured for coupling the first component to the second component for pivotal movement relative to one another. The hinge module set includes a first hinge module, such as hinge module 100, configured to control relative pivotal movement of the first and second components in a first pivot direction 190 (FIGS. 1C and 1D), and a second hinge module, such as hinge module 200, configured to control relative pivotal movement of the first and second components in a second pivot direction 290 (FIGS. 2C and 2D). Additionally or optionally, the first pivot direction 190 is opposite the first direction 190.

In an exemplary embodiment, each of hinge modules 100 and 200 is designated for installation at a specific side or position on the pivot axis 108, so that the hinge modules 100, 200 apply the same amount of frictional resistance to pivot motion in the same directions. Additionally or optionally, hinge modules 100 and 200 include geometric features that ensure that the hinge modules are only installed on the correct side or position. In one non-limiting example, the first hinge module 100 comprises a first indicia 180 corresponding to a first mounting location, and the second hinge 200 module comprises a second indicia 280 corresponding to a second mounting location opposite the first mounting location. In this configuration. The first indicia and/or second indicia 280 includes a surface indentation or notch. In addition, hinge module 100 may have a profile shape that is the mirror image of a profile shape of hinge module 200.

Additional details of the hinge modules 100, 200 are discussed below.

As illustrated in FIGS. 1A-1F and 2, the hinge module 100 generally includes a torque element 102, a housing 104, and a shaft 106 defining a pivot axis 108. In an exemplary embodiment, housing 104 has a side wall 114 and an end cap 110. The end cap 110 and side wall 114 define an interior space 118, which as shown in at least FIG. 2, is configured to receive torque element 102. In an exemplary embodiment, the interior surface 118, supplemental to the slot 132, is configured to secure the torque element 102 inside the housing 104 and prevent the torque element 102 from rotation relative to the housing 104.

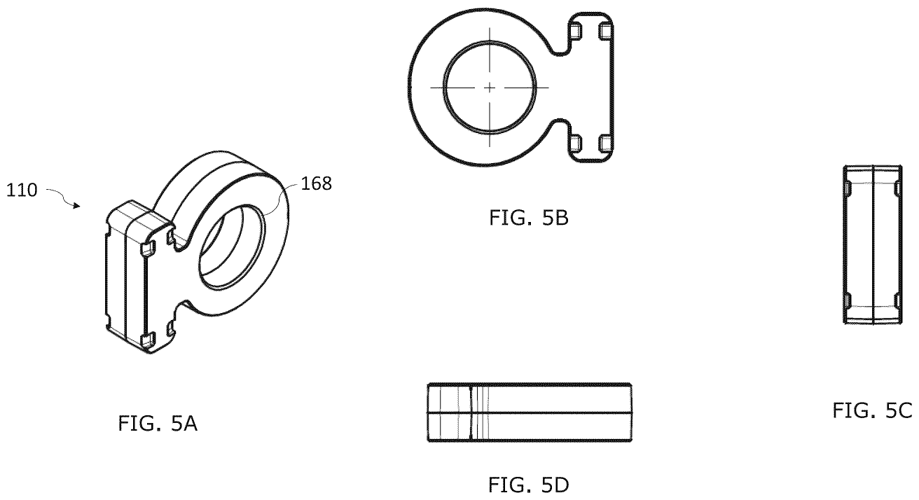

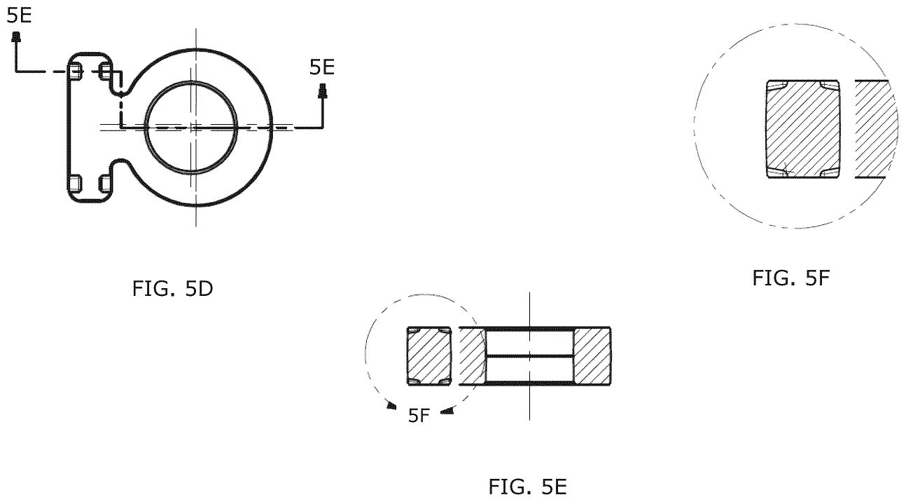

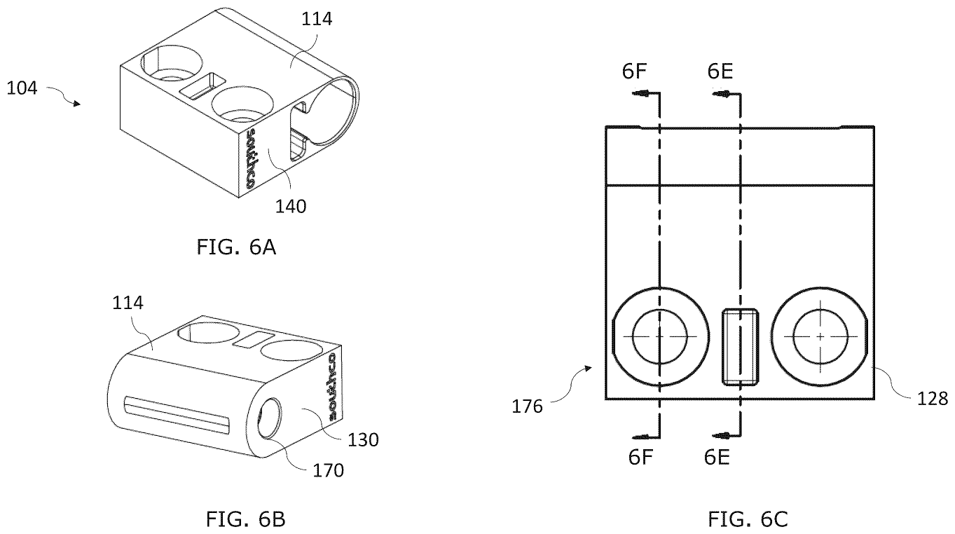

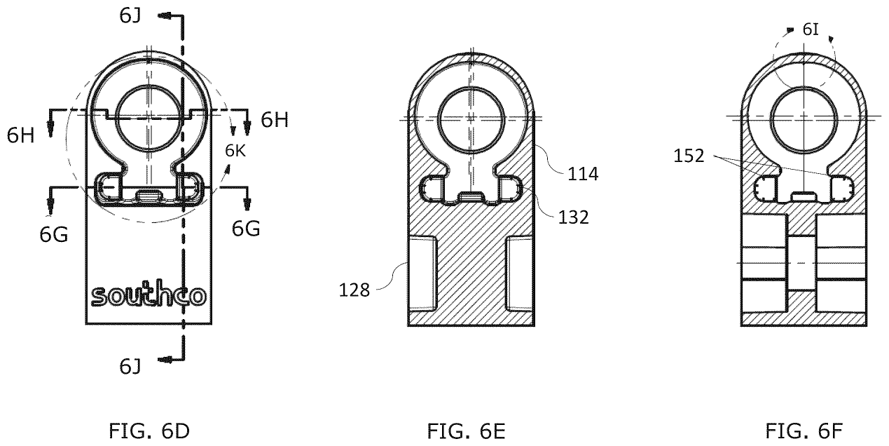

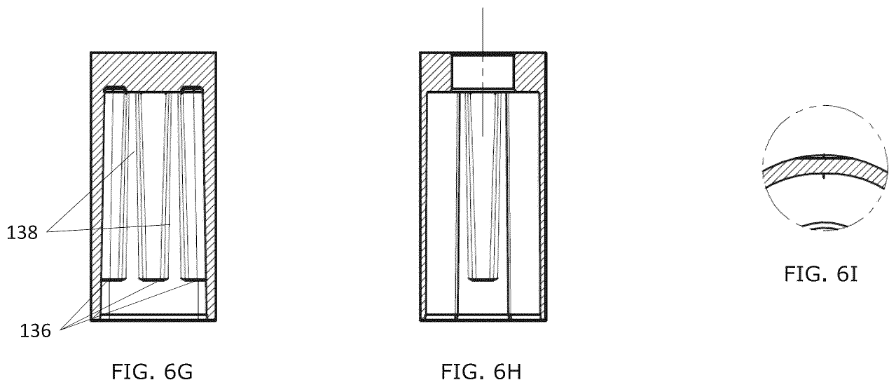

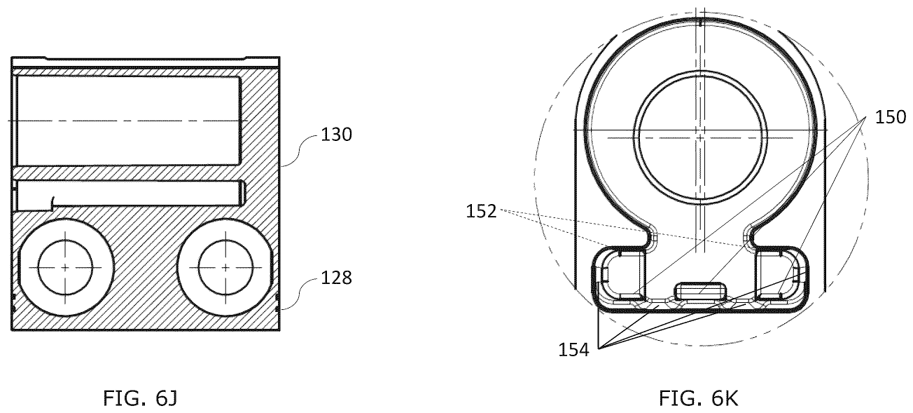

In a non-limiting example, as shown in FIGS. 5A-5F and 6B, the end cap 110 defines a first aperture 168 and the rear wall 130 defines a second aperture 170. The first aperture 168 and the second aperture 170 are aligned with the pivot axis 108 of the shaft 106, such that the shaft 106 extends through at least the first aperture 168, the interior space 118 of the housing 104, and the second aperture 170. Still further, the aperture 116 of the torque element 102 is also aligned with the pivot axis 108 of the shaft 106, such that the shaft 106 extending through the first aperture 168, the aperture 116, the interior space 118 of the housing 104, and the second aperture 170. Thus, the shape and size of the end cap 110 generally follows the contours of the torque element 132 or a portion of the housing 104, such as at least the slot 132 and a curved arm opening 172 defined by side wall 114. Additionally or optionally, housing 104 includes an adapter 112 having an end portion that is configured to be coupled to a portion of shaft 106 and an opposite end portion that is configured for releasable coupling to the first component.

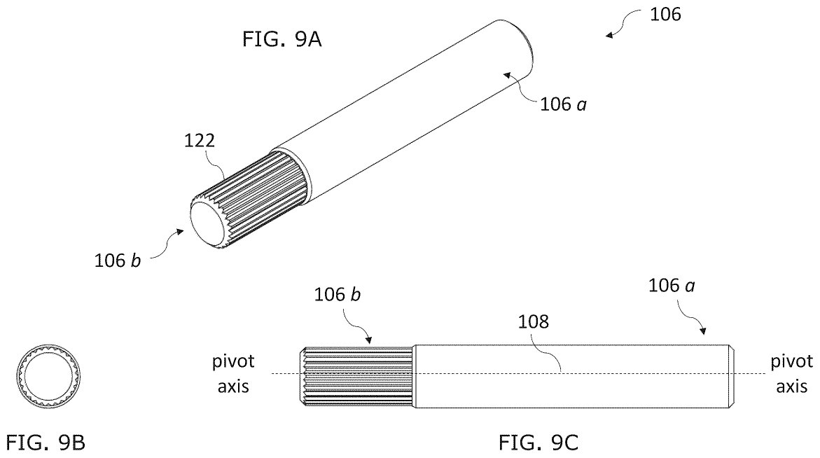

Referring briefly to FIGS. 9A-9C, shaft 106 has a proximal end 106 a and a distal end 106 b opposite the proximal end 106 a. Distal end 106 b includes a head 120 having a reduced diameter relative to other sections of shaft 106. Distal end 106 b defines a coupling surface 122 such as a spline or knurled surface, which can cooperate with a coupling element to connect the hinge module 100 to the first component. When assembled, the shaft 106 is positioned central to the housing 104 in order to sufficiently support the shaft 106 radially. For example, the shaft 106 is positioned central to the housing 104 with respect to two end portions or parallel faces formed by housing 104, in order to sufficiently support the shaft radially.

In an exemplary embodiment, the torque element 102 is configured for frictionally engaging the shaft 106. In a non-limiting example, the torque element 102 defines an aperture 116 for frictionally engaging shaft 106. The amount of frictional resistance provided by torque element 102 depends in part on the amount of surface area of the torque element 102 that contacts shaft 106. Accordingly, the thickness of a single torque element 102 can be varied to change the frictional resistance. Also, the respective dimensions (outer dimension of the shaft 106 and inner dimension of the torque element 102) can be modified to increase or decrease the frictional resistance.

In FIG. 2, plural torque elements 102 are visible. It will be understood, however, that one or more additional torque elements can be received in interior space 118 and stacked adjacent each other. Incorporating additional torque elements 102 increases the total surface area that frictionally engages shaft 106, and therefore increases the amount of frictional resistance provided by hinge module 100. Conversely, a single torque element (or less than the number of torque elements 102 illustrated in FIG. 2) is also contemplated, such as based on the amount of desired frictional resistance provided by hinge module 100. Thus, the amount of frictional resistance provided by hinge module 100 can be increased by placing additional torque elements in interior space 118 to increase the total thickness of torque elements, and/or by replacing one or more torque elements 102 with a thicker torque element 102 having a greater surface area in contact with shaft 106.

Furthermore, as seen in FIG. 2, the plural torque elements 102 a may be oriented or placed in a first position. It will be understood however, that one or more torque elements 102 can be placed within interior space 118 in a second position and the second position is different from the first position (e.g., second position is opposite the first position). Specifically, torque element 102 a can be placed in a first position and torque element 102 b in a second position; torque element 102 a can be placed in a first position and torque element 102 b in a first position; torque element 102 a can be placed in a second position and torque element 102 b can be placed in a second position; and any combination thereof, inclusive of the variation in number of torque elements 102 included. Still further, the shape and positioning of the torque elements 102 can be used to provide symmetrical torque (same frictional resistance in both directions of rotation) or asymmetrical torque (different frictional resistances in opposite directions of rotation).

In an exemplary embodiment, as illustrated in FIGS. 6A-6F, the housing 104 has a cover 140, a housing base 128, a side wall 114, and a rear wall 130. Cover 140, housing base 128, side wall 114, and rear wall 130 may be integrally formed as a single body of unitary construction that is separate from end cap 110. The formation of one-piece housing body can be formed by molding, casting, stamping, machining, or other known processes. Alternatively, however, cover 140, housing base 128, side wall 114, and rear wall 130 may each be formed separately and later joined to one another, such as by welding, adhesive, thermal bonding, or mechanical fastening. Together, the cover 140, housing base 128, side wall 114, and rear wall 130 define an interior space 118 configured to receive at least one torque element 102. In an exemplary embodiment, the housing 104 also comprises a mounting surface 176 configured to be mounted to the first or second component. When the mounting surface 176 is configured for coupling to the first component, then a mounting surface 126 of an optional adapter 112 (discussed below) is configured for coupling to the second component. In a non-limiting example, the mounting surface 176 of housing 104 extends downwardly relative to the pivot axis 108.

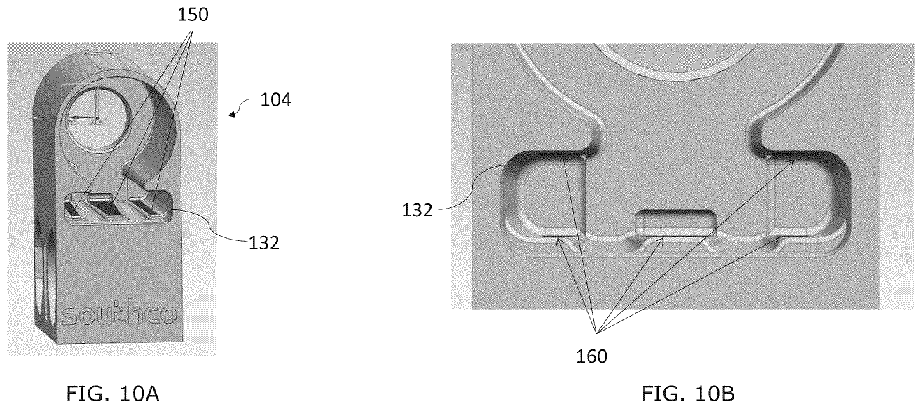

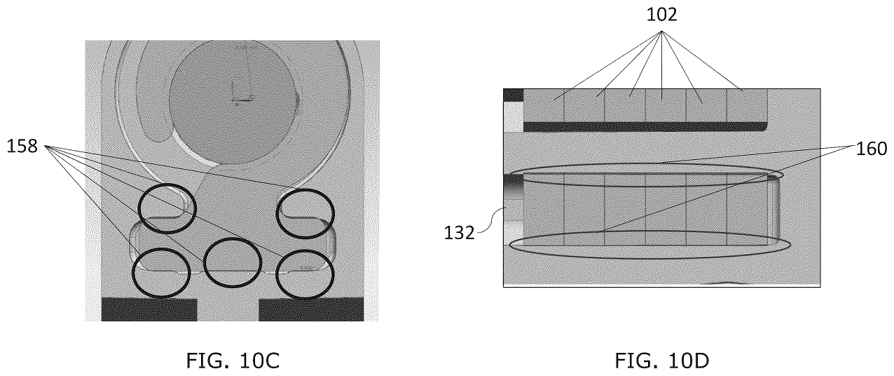

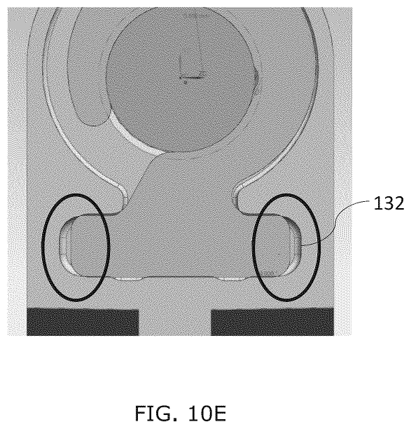

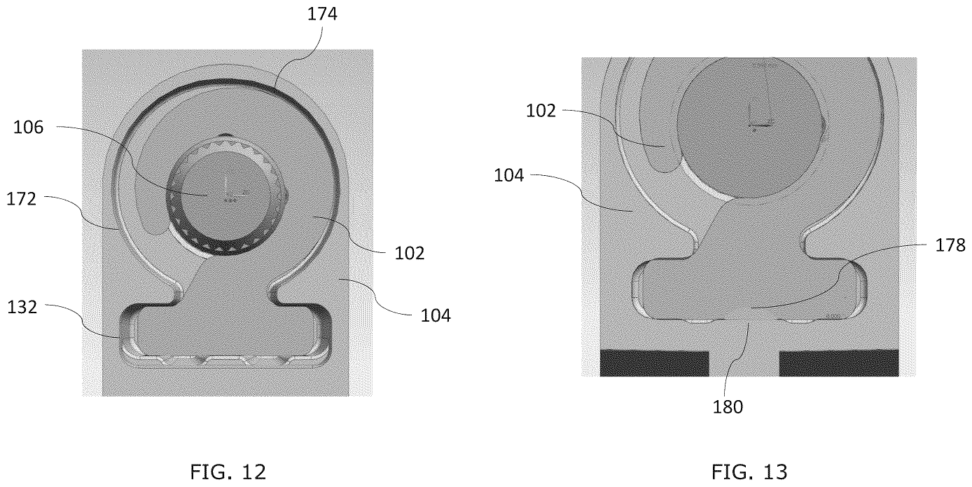

In particular, the housing 104 includes a slot 132 configured to receive at least a portion of the torque element 102. In an exemplary embodiment, the slot 132 includes a periphery 134. As best illustrated in FIGS. 6E, 6F, and 6K, the periphery 134 comprises a plurality of ridges 136 and grooves 138, each of the ridges 136 and 138 extending generally parallel to the pivot axis 108. In this configuration, the plurality of ridges 136 and grooves 138 form internal contact surfaces 160 (FIG. 10C) between the housing 104 and at least a portion of the torque element 102. In a non-limiting example, the internal contact surfaces 160 are between the housing 104 and a base or base portion 142 of the torque element 102. In an exemplary embodiment, the slot 132 is configured to at least partially receive a base portion 142 of the torque element 102. The slot 132 defines internal contact surfaces 160 including ridges 136 positioned for contact between the housing 104 and the base portion 142 of the torque element 102 and grooves 138 interposed between the ridges 136 and extending parallel to the pivot axis 108. The ridges 136 and the grooves 138 each define respective draft angles, with the draft angle of the ridges 136 being less than the draft angle of the grooves 138.

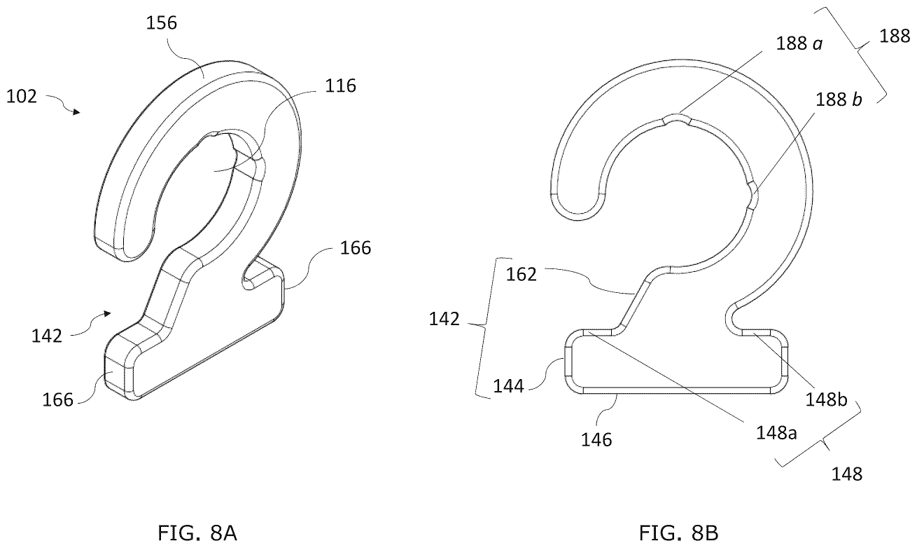

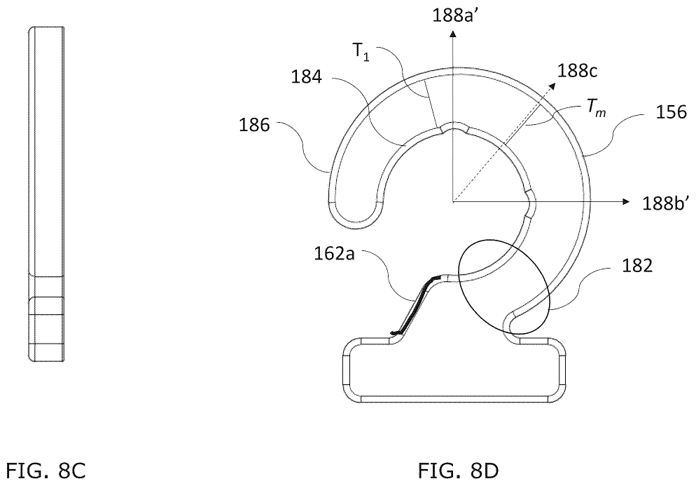

Briefly referring to FIGS. 8A-8D, the torque element includes a base 142 having a first portion 144. The dimensions of the torque element 102, as illustrated in FIGS. 8A-8D, is not intended to be limiting. In an exemplary embodiment, the first portion 144 of the base 142 includes a bottom long side 146 and a top flat surface 148 opposite the bottom long side 146. In a non-limiting example, the first portion 144 further comprises first and second short sides 166, with the short sides 166 each being relatively shorter than the bottom long side 146.

Additionally or optionally, as shown in FIG. 13, the bottom long side 146 of the base 142 comprises a concave recess 178 configured to receive a center rib 180 defined by the slot 132. The recess 178 would improve alignment and radial loading from the friction shaft 106. This optional feature (including an optional concave recess in the element center and a corresponding convex (conical) rib in the center of the housing recess) can help with distributing the loads and forces on the element from the friction on the shaft and the torque reversals in the hinge operation. The element loads can be a factor on the fatigue life of the housing, and this feature can help distribute the loads for high cycle life (fatigue life). Additionally, this radial feature could be any alternative shape, including triangular or rectangular, to further manage the loads in the hinge assembly.

In this way, the slot 132 has a shape and size that is configured to receive at least the first portion 144 of the base 142 of the torque element 102. In an exemplary embodiment, the slot 132 is defined by a plurality of straight edges and corner regions. In an exemplary embodiment, the top flat surface 148 comprises a first top flat surface 148 a and a second top flat surface 148 b. Each first top flat surface 148 a and second top flat surface 148 b extend from the base 142 of the torque element 102. In one non-limiting example, the first top flat surface 148 a and the second top flat surface 148 b extends from a second portion 162 (discussed below) of the base 142 of the torque element 102.

Specifically, the internal contact surfaces comprise (i) ridge contact surfaces 150 between the housing 104 and the bottom long side 146 of the base 142 of the torque element 102. Additionally or optionally, the internal contact surfaces comprise (ii) periphery contact surfaces 152 between the housing 104 and the top flat surface 148 of the base 142 of the torque element 102. Further, the internal contact surfaces include (iii) slot contact surfaces 154 between the housing 104 and the first portion 144, excluding the ridge contact surfaces 150 and the periphery contact surfaces 152. In addition, the ridge contact surfaces 150 and the periphery contact surfaces 152 each define respective minimum draft angles, with each respective minimum draft angles each being less than respective draft angles defined by the slot contact surfaces 154. In an exemplary embodiment, the slot 132 defines internal contact surfaces 160 including ridges 136 positioned for contact between the housing 104 and the base portion 142 of the torque element 102 and grooves 138 interposed between the ridges 136 and extending parallel to the pivot axis 108. The ridges 136 and the grooves 138 each define respective draft angles, with the draft angle of the ridges 136 being less than the draft angle of the grooves 138.

Referring now to FIGS. 10A-10E, in an exemplary embodiment, the ridge contact surfaces 150 and the periphery contact surfaces 152 form parallel contact lines, and the contact lines are perpendicular to the pivot axis 108 of the shaft 106, thereby preventing rotation of the torque element 102 relative to the housing 104. In this configuration, retention of the torque element 102 within the slot 132 and the housing 104 is achieved from interference among the surfaces or faces of the base 142 of the torque element 102 (i.e. the “T” shape of the base 142). As illustrated in FIG. 10C, the design interference is denoted by areas 158 at the top flat surfaces 148 and bottom long side 146 of the base 142 of the torque element 102. The resistance to rotation of the torque element 102 is facilitated, in part, from this interference when the shaft 106 is rotated in a counterclockwise (CCW) or clockwise (CW) direction. In an exemplary embodiment, as shown in FIG. 10C, the areas of interference 158 are formed by the interface between ridge contact surfaces 150 and portions of the bottom long side 146, as well as the periphery contact surfaces 152 and top flat surfaces 148. In this way, a conventional housing crimp operation or a coil or solid pin to secure torque elements 102 within the housing 104 is avoided or rendered unnecessary.

In an exemplary embodiment, as best shown in FIGS. 10A, 10D, and 10E, the plurality of ridges 136 and grooves 138 extend along an entirety of a length of the interior space 118 of the housing 104. In this configuration, as shown in FIG. 10D the internal contact surfaces 160 provide sufficient support, such that that a depth of the slot 132 and required draft in the slot 132 sufficiently mitigates or prevents the torque element 102 from radial motion, when assembled in housing 104. In contrast, the at least one torque element 102 may be adjusted along a lateral direction within slot 132 (left to right, or vice versa) in the housing 104 to reach a central position relative to the housing 104. In so doing, the torque element 102 is configured to absorb dimensional variations that are common in the manufacturing processes of the housing 104 and the torque element 102. In an exemplary embodiment, as shown in FIG. 10E, the slot 132 has a perimeter, at least a portion of which is larger than a perimeter of the base 142 of the torque element 102. Thus, when the hinge module 100 is assembled, the slot 132 is adapted for press fit engagement with at least the first portion 144 of the base 142 of the torque element 102, thereby securing the torque element 102 relative to the housing 104.

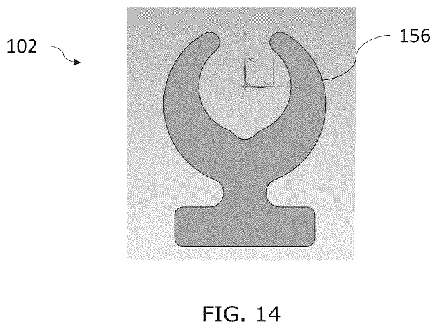

Returning to FIGS. 8A-8D, in an exemplary embodiment, the torque element 102 comprises the base 142 having a first portion 144 and a second portion 162. The second portion 162 comprises a ramped or slanted surface 162a connecting the first portion 144 to the curved arm 156, such that an end portion of curved arm 156 and at least the slanted surface 162a of the second portion 162 together form transition area 182 (or transition area 182 is between second portion 162 and the end portion of the curved arm 156). Extending from the base 142 is a curved arm 156. Particularly, extending from the second portion 162 of the base 142 is the curved arm 156. In one non-limiting example, as shown in FIGS. 8A-8D, the curved arm 156 comprises a sickle shape, such that the torque element 102 is asymmetric. Alternatively, as shown in FIG. 14, the curved arm 156 comprises an omega shape, such that the torque element 102 is symmetric. Regardless of the shape of the curved arm 156, the curved arm opening 172 has a size and shape configured to receive at least the curved arm 156 of the torque element 102.

Conventionally, a stamped torque element 102 having an omega shaped curved arm 156 is secured within housing 104 at the thickest portion of the omega shape in order to manage the stress levels due to cyclic torque reversals (fatigue stress) the base 142 of the torque element 102, while preserving the shape or geometric packaging of the torque element 102 for generating the desired friction torque. In the case of a stamped torque element 102 having a sickle shape curved arm 156, as illustrated in FIGS. 8A-8D, one of the challenges is to manage the stress levels applied to the transition area 182 formed by the second portion 162 and curved arm 1563 together, since transition area 182 is conventionally prone to failure from fatigue. Another challenge is controlling design tolerance and manufacturing tolerances to ensure fit of the torque element 102 within housing 104. A proper fit would desirably avoid excessive radial play (e.g., movement of torque element 102 within housing 104) from too loose a fit, or too much interference that could potentially lead to component/assembly failure, or difficulty in assembly.

To at least partially address these challenges, selection of die cast zinc materials would enable precision die casting methods to be employed. In an exemplary embodiment, using die cast zinc materials would enables formation of the minimum (e.g. very small) draft angles defined by ridges 136 being less than the draft angle of the grooves 138, while increasing the coring in the remainder of the slot 132 or housing 104 (e.g., as defined by the slot contact surfaces 154). The change in the draft on the non-critical to function faces (e.g. slot contact surfaces 154) helps the robustness of the manufacturing process for the die cast housing 104. This allows for controlling the die casting process with respect to die adhesion. Although precision (zinc) die castings can be utilized for the housings to provide the geometry, other manufacturing methods can be used, including methods that may require CNC machining or other techniques to accommodate draft features.

In addition to the design of the housing 104 and slot 132, addressing the challenges additionally or optionally requires improvement in the torque element 102 design. In an exemplary embodiment, and as best shown in FIGS. 8B and 8D, the inside diameter 184 of the torque element comprises two notches 188 comprising first notch 188a and second notch 188b. The notches 188 are arranged along the side diameter 184, such that a line drawn along a horizontal or x direction (e.g., radially outward and horizontally to the right relative to the pivot axis 108) defined from a centerline of the pivot axis 108 or shaft 106 (when shaft 106 is extends aperture 116 of torque element 102) to notch 188b forms an axis 188b′. Correspondingly, a line drawn along a vertical or y direction (e.g., radially outward and upwardly relative to the pivot axis 108) defined from a centerline of the pivot axis 108 or shaft 106 (when shaft 106 is extends aperture 116 of torque element 102) to notch 188a forms an axis 188a′. In this way, axes 188a′ and 188b′ create a 90° angle, such that an axis 188c extending along the 45° angle between axes 188a′ and 188b′ defines a maximum thickness (Tₘ) of the curved arm 156 of the torque element 102. Generally, the thickness (T) is a distance between the inner diameter 184 and outer diameter 186 of the curved arm 156 of the torque element 102. The maximum thickness (Tₘ) is greater than a thickness outside the area between axes 188a′ and 188b′, such as thickness T₁.

In this configuration, the expansion of an inside diameter 184 of the torque element 102 when the shaft 106 is pressed into the torque element 102 would not change the distance between the tangent and the inside diameter 184 of the torque element 102. For installation of the shaft 106 and torque element 102 into the housing 104, the tolerances of the fits can be controlled from the interface or contact face between the shaft 106 and the torque element 102 in the housing 104. The dimensions (e.g. width) of the slot 132 in the housing 104 can also be controlled for ease of installation and ensuring proper fit. Additionally or optionally, a distance between a center line of the shaft 106 and a portion of the curved arm opening 172 is greater than another distance between a center line of the torque element 102 to the second portion 162 of the base 142.

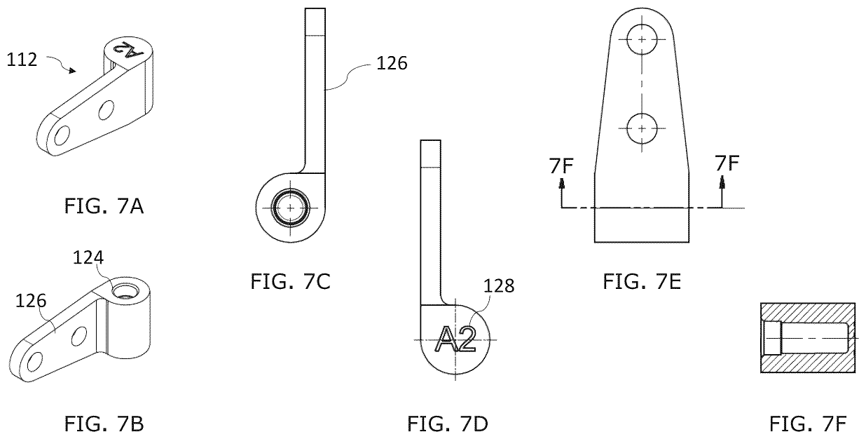

In one embodiment, as illustrated in FIGS. 7A-7D, the adapter 112 defines an opening 124 to receive a portion of an end of shaft 106. In an exemplary embodiment, the opening 124 is configured to receive a portion of a distal end 106 b of shaft 106 (FIGS. 9A-9C). Further the opening 124 is configured to receive the coupling surface 122 of the distal end 106 b of shaft 106. In a non-limiting example, the adapter defines a counterbore opening to receive a portion of the end portion of the shaft 106, such as at least the coupling surface 122 of the distal end 106 b of shaft 106. Additionally or optionally, the adapter 112 defines the mounting surface 126 configured for coupling to the first or second component. When the mounting surface 126 is configured for coupling to the first component, then the mounting surface 176 is configured for coupling to the second component. It will be understood that other types of couplings can be attached to the distal ends 106 b of shaft 106 in accordance with the invention.

By providing an adapter such as adapter 112, it is possible to adapt the hinge module for use in a system configured for disassembly. For example, shaft 106 may be designed for permanent or semi-permanent fixation to the first component. Such fixation may be desirable to prevent or resist unintended disassembly or tampering or inadvertent loosening of the hinge module 100. If it is desired to adapt the hinge module for use in a system configured for disassembly, an adapter such as adapter 112 can be provided to convert the hinge assembly to a more easily removable assembly. This may be advantageous for facilitating repair and replacement of the hinge assembly, retrofitting of the hinge assembly, or removal for cleaning or access to interior components.

When the hinge module 100 is assembled, as shown in FIG. 10E, a gap 174 is formed between the curved arm opening 172 of the housing 104 and the torque element 102. In an exemplary embodiment, the gap 174 comprises a reservoir configured to receive a lubricant, including but not limited to, grease. In assembling the hinge module 100, lubricant may be applied to torque element 102 or housing 105. The flow of lubricant may be guided by gap 174.

In addition, the components and details regarding hinge module 200 generally corresponds to those of hinge module 100. In an exemplary embodiment, as shown in FIGS. 3A-3F and 4, the torque element 202, housing 204, shaft 206 having pivot axis 208, have similar details and functions as torque element 102, housing 104, and shaft 106 defining pivot axis 108. Similarly, housing 204 has a side wall 214 and an end cap 210, the details of which are similar to that of side wall 114 and end cap 110. The end cap 210 and side wall 214 define an interior space 218, which as shown in at least FIG. 4, is configured to receive torque element 202. In an exemplary embodiment, the interior surface 118, supplemental to the slot 232, is configured to secure the torque element 202 inside the housing 104 and prevent the torque element 202 from rotation relative to the housing 204.

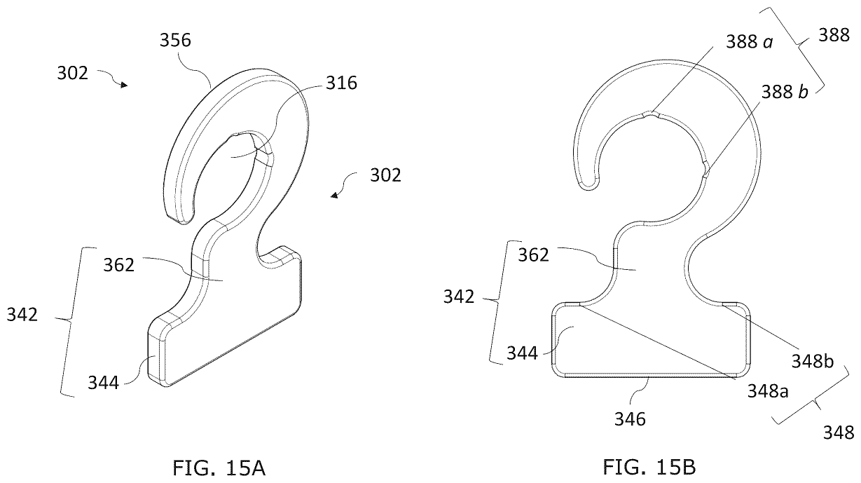

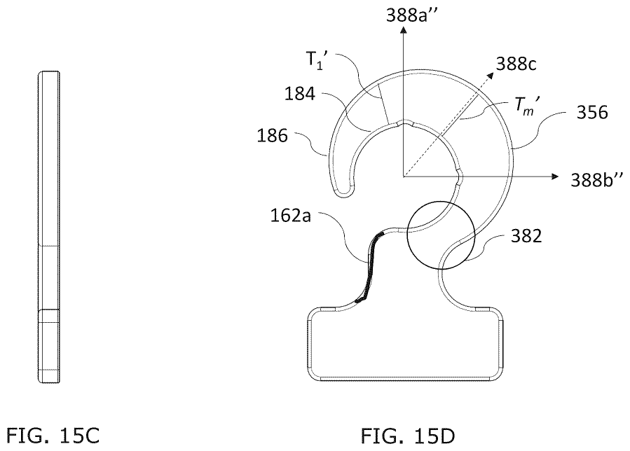

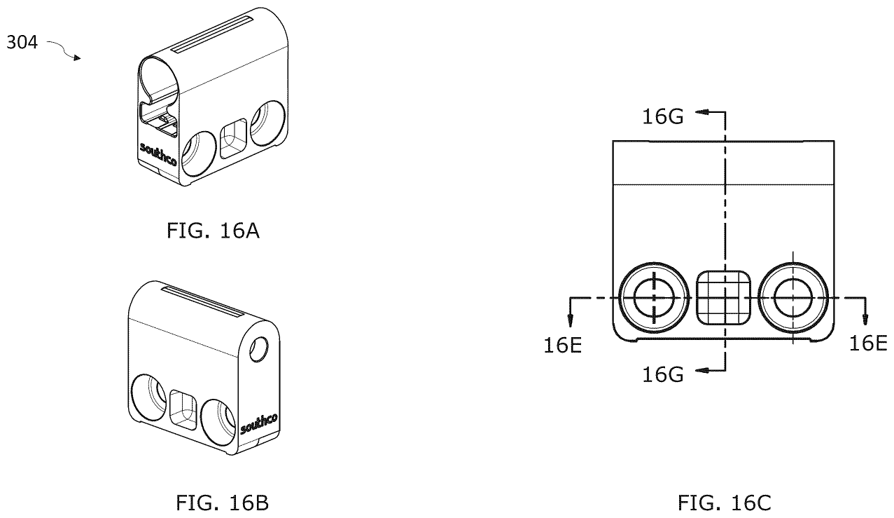

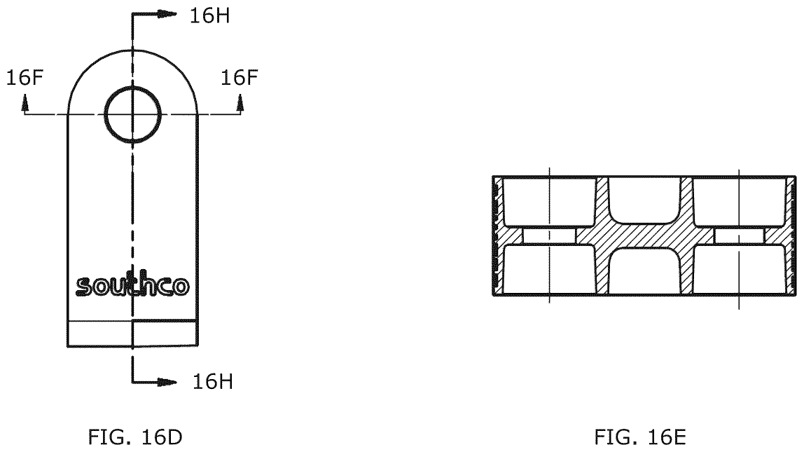

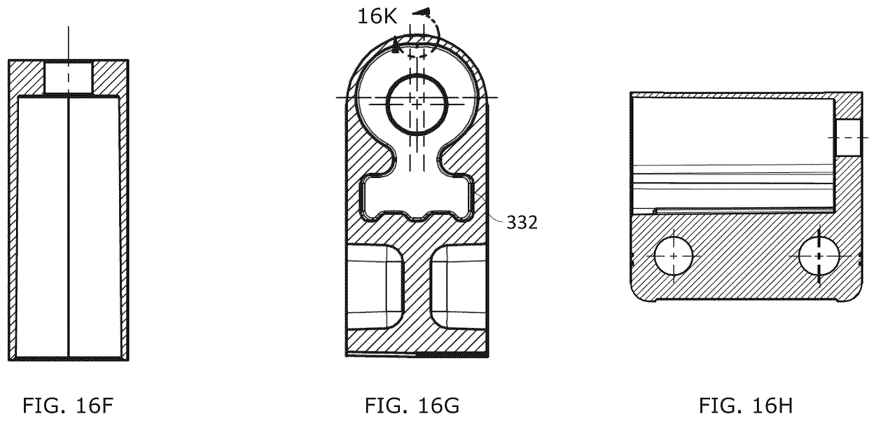

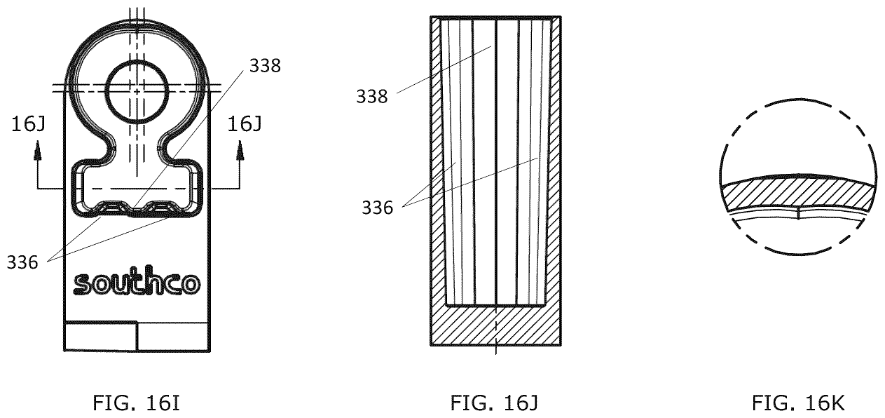

A second embodiment of hinge module 100, 200 in accordance with aspects of the invention is disclosed in FIGS. 15A-15D and 16A-16K. Specifically, the FIGS. 15A-15D depicts views of a torque element 302, the details of which generally corresponds to the torque element 102 as described above, whereas FIGS. 16A-16K depicts views of the corresponding housing 304 configured to receive the torque element 102, and the housing 104 generally corresponds to the details of the housing 104 as described above. However, they differ in some respects.

In an exemplary embodiment, as shown in FIGS. 15A-15D, the torque element 302 includes a base portion 342 and curved arm 356, the details of each of which correspond respectively to those of base portion 142 and curved arm 156, as described above. The base portion 342 comprises a first portion 344 and a second portion 362. The second portion 362 is similar to second portion 162, except that the second portion 362 comprises a vertical surface or profile relative to the illustrated ramped or slanted surface 162a (as shown in FIGS. 8B and 8D) of torque element 102. Second portion 362 connects the first portion 344 to the curved arm 356, such that an end portion of curved arm 356 and at least the vertical surface 362a of the second portion 362 together form transition area 382 (or transition area 3182 is between second portion 362 and the end portion of the curved arm 356). Additionally or optionally, the changes in the shape or profile of the second portion 362 allows for use of a larger torque element 302 (in size or dimensions).

Still further, as shown in FIG. 8D, the inside diameter 384 of the torque element comprises two notches 388 comprising first notch 388a and second notch 388b, each of which generally correspond to inside diameter 184, notches 188, first notch 188a, and second notch 188b, respectively, of the torque element 102, as described above. The notches 388 are arranged along the inside diameter 384, such that a line drawn along a horizontal or x direction (e.g., radially outward and horizontally to the right relative to the pivot axis 308) defined from a centerline of the pivot axis 308 to notch 388b forms an axis 388b″. Correspondingly, a line drawn along a vertical or y direction (e.g., radially outward and upwardly relative to the pivot axis 308) defined from a centerline of the pivot axis 108 to notch 388a forms an axis 388a″. In this way, axes 388a″ and 388b″ create a 90° angle, such that an axis 388c extending along the 45° angle between axes 388a″ and 388b″ defines a maximum thickness (Tₘ) of the curved arm 356 of the torque element 302. Generally, the thickness (T′) is a distance between the inner diameter 384 and outer diameter 386 of the curved arm 356 of the torque element 302. The maximum thickness (Tₘ) is greater than a thickness outside the area between axes 388a′ and 388b′, such as thickness T₁′.

Correspondingly, as shown in FIGS. 16A-16K, the housing 304 generally corresponds to the housing 104. In an exemplary embodiment, the slot 332 is configured to at least partially receive a base portion 342 of the torque element 302. The slot 332 defines internal contact surfaces including ridges 336 positioned for contact between the housing 304 and the base portion 342 of the torque element 302 and grooves 338 interposed between the ridges 336 and extending parallel to the pivot axis 308 (the details of which correspond generally to that of pivot axis 108 as described above). The ridges 336 and the grooves 338 each define respective draft angles, with the draft angle of the ridges 336 being less than the draft angle of the grooves 338. However, in general, housing 304 has a smaller number of ridges 336 (and corresponding grooves 338) relative to the number of ridges 136 (and corresponding grooves 138) of housing 104. For example, as can be seen by a comparison of housing 104 illustrated FIGS. 6E and 6G with housing 304 FIGS. 16G and 16J, respectively, housing 304 includes two ridges 336 and one groove 338 (vs. three ridges 136 and two grooves 338 as best shown in FIG. 10B). However, one skilled in the art would understand that the numbers of grooves and ridges as illustrated in the figures are not intended to be limiting, but are rather for the purposes of showing non-limiting examples. Other combinations of the numbers of ridges and corresponding grooves are contemplated and are within the spirit of the invention. Additionally or optionally, the changes in the shape or profile of the slot 132 comprising the ridges 136 and grooves 138 allows for facilitating proper alignment, fit, and security of larger torque element 302 (in size or dimensions).

This invention includes, but is not limited to, the following aspects:
1. A hinge module for coupling components for pivotal movement relative to one another, the hinge module comprising:
a shaft defining a pivot axis;
a torque element frictionally engaging the shaft, the torque element comprising a base portion;
a housing defining a slot configured to at least partially receive the base portion of the torque element;
wherein the slot defines internal contact surfaces including ridges positioned for contact between the housing and the base portion of the torque element and grooves interposed between the ridges and extending parallel to the pivot axis; and wherein the ridges and the grooves each define respective draft angles, the draft angle of the ridges being less than the draft angle of the grooves.
2. The hinge module of aspect 1, wherein the torque element includes a curved arm extending from the base portion.
3. The hinge module of aspect 2, wherein the curved arm of the torque element comprises a sickle shape.
4. The hinge module of aspect 2, wherein the curved arm of the torque element comprises an omega shape.
5. The hinge module of aspect 1, wherein the slot defines ridge contact surfaces and periphery contact surfaces, the ridge contact surfaces and the periphery contact surfaces form parallel contact lines relative to each other, and the contact lines are perpendicular to the pivot axis of the shaft, thereby preventing rotation of the torque element relative to the housing.
6. The hinge module of aspect 1, wherein the housing further comprises side wall, a rear wall, and an end cap, wherein the side wall, the rear wall, and the end cap together define an interior space within the housing, the interior space being configured to receive the torque element inside the housing.
7. The hinge module of aspect 6, wherein the plurality of ridges and grooves extend along an entirety of a length of the interior space of the housing.
8. The hinge module of aspect 2, wherein the base portion includes a base section from which the curved arm extends.
9. The hinge module of aspect 8, wherein a top flat surface of the base portion comprises a first top flat surface and a second top flat surface.
10. The hinge module of aspect 9, wherein the base portion further comprises first and second short sides, the short sides each being relatively shorter than a bottom long side of the base portion.
11. The hinge module of aspect 1, wherein the slot defines a plurality of straight edges and corner regions.
12. The hinge module of aspect 1, wherein the slot has a perimeter, at least a portion of which is larger than a perimeter of the base portion of the torque element, such that when the hinge module is assembled, the slot is adapted for press fit engagement with the base portion of the torque element, thereby securing the torque element relative to the housing.
13. The hinge module of aspect 6, wherein the end cap defines a first aperture and the rear wall defines a second aperture, the first aperture and the second aperture being aligned with the pivot axis of the shaft, with the shaft extending through at least the first aperture, the interior space of the housing, and the second aperture.
14. The hinge module of aspect 8, wherein the housing defines a curved arm opening configured to receive at least the curved arm of the torque element.
15. The hinge module of aspect 14, wherein when the hinge module is assembled, a gap formed between at least a portion of the curved arm opening and the torque element comprises a reservoir configured to receive a lubricant.
16. The hinge module of aspect 15, wherein the lubricant includes grease.
17. The hinge module of aspect 1, wherein the housing comprises a mounting surface configured to be mounted to one of the components.
18. The hinge module of aspect 17, wherein the mounting surface extends downwardly relative to the pivot axis.
19. The hinge module of aspect 1, further comprising an adapter configured for fixed coupling to an end portion of the shaft.
20. The hinge module of aspect 19, wherein the adapter defines an opening to receive at least a portion of the end portion of the shaft.
21. The hinge module of aspect 19, wherein the adapter includes another mounting surface configured for fixed coupling to one of the components.
22. The hinge module of aspect 14, wherein the torque element defines an aperture aligned with the pivot axis of the shaft, with the shaft extending through the aperture in frictional engagement with the torque element.
23. The hinge module of aspect 22, wherein a distance between a center line of the shaft and a portion of the curved arm opening is greater than another distance between a center line of the torque element to a portion of the base portion.
24. The hinge module of aspect 1, wherein the housing has an interior surface, supplemental to the slot, configured to secure the torque element inside the housing and prevent the torque element from rotation relative to the housing.
25. The hinge module of aspect 1, further comprising plural torque elements frictionally engaging the shaft.
26. The hinge module of aspect 4, wherein a bottom long side of the base portion comprises a concave recess configured to receive a center rib defined by the slot.
27. A hinge module for coupling components for pivotal movement relative to one another, the hinge module comprising:
a torque element comprising a base portion and a curved arm extending from the base portion, the curved arm having an outer diameter and an inner diameter;
wherein the inner diameter comprises at least two notches positioned relative to each other, thereby defining a first axis extending upwardly relative to a center of the inner diameter and through the first notch and a second axis extending laterally relative to the center of the inner diameter and through the second notch, the first axis being angled 90 degrees relative to the second axis; and
wherein a maximum thickness between the inner diameter and the outer diameter is taken along a direction between the first axis and the second axis, the direction being angled 45 degrees relative to the first axis or second axis.
28. The hinge module of aspect 27, further comprising:
a shaft defining a pivot axis, wherein the torque element frictionally engages the shaft;
a housing defining a slot configured to receive at least a portion of the base portion of the torque element, the base portion comprising a bottom long side and a top flat surface opposite the bottom long side;
wherein the slot includes a plurality of ridges and grooves extending parallel to the pivot axis;
wherein the plurality of ridges and grooves form internal contact surfaces between the housing and at least a portion of the base portion of the torque element, the contact surfaces comprising (i) ridge contact surfaces between the housing and the bottom long side of the base portion of the torque element, (ii) periphery contact surfaces between the housing and the top flat surface of the base portion of the torque element, and (iii) slot contact surfaces between the housing and the base portion, excluding the ridge contact surfaces and the periphery contact surfaces; and
wherein the ridge contact surfaces and the periphery contact surfaces each define respective minimum draft angles, the respective minimum draft angles each being less than respective draft angles defined by the slot contact surfaces.
29. The hinge module of aspect 27, wherein the curved arm of the torque element comprises a sickle shape.
30. The hinge module of aspect 27, wherein the curved arm of the torque element comprises an omega shape.
31. The hinge module of aspect 28, wherein the housing further comprises a rear wall and an end cap, wherein the side wall, the rear wall, and the end cap together define an interior space within the housing, the interior space being configured to receive the torque element inside the housing.
32. The hinge module of aspect 28, wherein the plurality of ridges and grooves extend along an entirety of a length of the interior space of the housing.
33. The hinge module of aspect 28, wherein the slot is defined by a plurality of straight edges and corner regions.
34. The hinge module of aspect 28, wherein the slot has a perimeter, at least a portion of which is larger than a perimeter of the base portion of the torque element, such that when the hinge module is assembled, the slot is adapted for press fit engagement with at least a portion of the base portion of the torque element, thereby securing the torque element relative to the housing.
35. The hinge module of aspect 31, wherein the end cap defines a first aperture and the rear wall defines a second aperture, the first aperture and the second aperture being aligned with the pivot axis of the shaft, with the shaft extending through at least the first aperture, the interior space of the housing, and the second aperture.
36. The hinge module of aspect 28, wherein the housing defines a curved arm opening configured to receive at least the curved arm of the torque element.
37. The hinge module of aspect 36, wherein when the hinge module is assembled, a gap formed between the curved arm opening and the torque element comprises a reservoir configured to receive a lubricant.
38. The hinge module of aspect 37, wherein the lubricant includes grease.
39. The hinge module of aspect 28, wherein the housing comprises a mounting surface configured to be mounted to one of the components.
40. The hinge module of aspect 39, wherein the mounting surface extends downwardly relative to the pivot axis.
41. The hinge module of aspect 28, further comprising an adapter configured for fixed coupling to an end portion of the shaft.
42. The hinge module of aspect 41, wherein the adapter defines an opening to receive a portion of the end portion of the shaft.
43. The hinge module of aspect 41, wherein the adapter includes another mounting surface configured for fixed coupling to one of the components.
44. The hinge module of aspect 28, wherein the torque element defines an aperture aligned with the pivot axis of the shaft, with the shaft extending through the aperture in frictional engagement with the torque element.
45. The hinge module of aspect 36, wherein a distance between a center line of the shaft and a portion of the curved arm opening is greater than another distance between a center line of the torque element to a portion of the base portion.
46. The hinge module of aspect 28, wherein the housing has an interior surface, supplemental to the slot, configured to secure the torque element inside the housing and prevent the torque element from rotation relative to the housing.
47. The hinge module of aspect 28, further comprising plural torque elements frictionally engaging the shaft.
48. The hinge module of aspect 28, wherein the base comprises a concave recess configured to receive a center rib defined by the slot.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A hinge module for coupling components for pivotal movement relative to one another, the hinge module comprising:
a shaft defining a pivot axis;
a torque element frictionally engaging the shaft, the torque element comprising a base portion;
a housing defining a slot configured to at least partially receive the base portion of the torque element;
wherein the slot defines internal contact surfaces including ridges positioned for contact between the housing and the base portion of the torque element and grooves interposed between the ridges and extending parallel to the pivot axis; and
wherein the ridges and the grooves each define respective draft angles, the draft angle of the ridges being less than the draft angle of the grooves.

2. The hinge module of claim 1, wherein the torque element includes a curved arm extending from the base portion.

3. The hinge module of claim 2, wherein the curved arm of the torque element comprises a sickle shape.

4. The hinge module of claim 2, wherein the curved arm of the torque element comprises an omega shape.

5. The hinge module of claim 1, wherein the slot defines ridge contact surfaces and periphery contact surfaces, the ridge contact surfaces and the periphery contact surfaces form parallel contact lines relative to each other, and the contact lines are perpendicular to the pivot axis of the shaft, thereby preventing rotation of the torque element relative to the housing.

6. The hinge module of claim 1, wherein the housing further comprises side wall, a rear wall, and an end cap, wherein the side wall, the rear wall, and the end cap together define an interior space within the housing, the interior space being configured to receive the torque element inside the housing.

7. The hinge module of claim 6, wherein the plurality of ridges and grooves extend along an entirety of a length of the interior space of the housing.

8. The hinge module of claim 2, wherein the base portion includes a base section from which the curved arm extends.

9. The hinge module of claim 8, wherein a top flat surface of the base portion comprises a first top flat surface and a second top flat surface.

10. The hinge module of claim 9, wherein the base portion further comprises first and second short sides, the short sides each being relatively shorter than a bottom long side of the base portion.

11. The hinge module of claim 1, wherein the slot defines a plurality of straight edges and corner regions.

12. The hinge module of claim 1, wherein the slot has a perimeter, at least a portion of which is larger than a perimeter of the base portion of the torque element, such that when the hinge module is assembled, the slot is adapted for press fit engagement with the base portion of the torque element, thereby securing the torque element relative to the housing.

13. The hinge module of claim 6, wherein the end cap defines a first aperture and the rear wall defines a second aperture, the first aperture and the second aperture being aligned with the pivot axis of the shaft, with the shaft extending through at least the first aperture, the interior space of the housing, and the second aperture.

14. The hinge module of claim 8, wherein the housing defines a curved arm opening configured to receive at least the curved arm of the torque element.

15. The hinge module of claim 14, wherein when the hinge module is assembled, a gap formed between at least a portion of the curved arm opening and the torque element comprises a reservoir configured to receive a lubricant.

16. The hinge module of claim 15, wherein the lubricant includes grease.

17. The hinge module of claim 1, wherein the housing comprises a mounting surface configured to be mounted to one of the components.

18. The hinge module of claim 17, wherein the mounting surface extends downwardly relative to the pivot axis.

19. The hinge module of claim 1, further comprising an adapter configured for fixed coupling to an end portion of the shaft.

20. The hinge module of claim 19, wherein the adapter defines an opening to receive at least a portion of the end portion of the shaft.

21. The hinge module of claim 19, wherein the adapter includes another mounting surface configured for fixed coupling to one of the components.

22. The hinge module of claim 14, wherein the torque element defines an aperture aligned with the pivot axis of the shaft, with the shaft extending through the aperture in frictional engagement with the torque element.

23. The hinge module of claim 22, wherein a distance between a center line of the shaft and a portion of the curved arm opening is greater than another distance between a center line of the torque element to a portion of the base portion.

24. The hinge module of claim 1, wherein the housing has an interior surface, supplemental to the slot, configured to secure the torque element inside the housing and prevent the torque element from rotation relative to the housing.

25. The hinge module of claim 1, further comprising plural torque elements frictionally engaging the shaft.

26. The hinge module of claim 4, wherein a bottom long side of the base portion comprises a concave recess configured to receive a center rib defined by the slot.

27. A hinge module for coupling components for pivotal movement relative to one another, the hinge module comprising:
a torque element comprising a base portion and a curved arm extending from the base portion, the curved arm having an outer diameter and an inner diameter;
wherein the inner diameter comprises at least two notches positioned relative to each other, thereby defining a first axis extending upwardly relative to a center of the inner diameter and through the first notch and a second axis extending laterally relative to the center of the inner diameter and through the second notch, the first axis being angled 90 degrees relative to the second axis; and
wherein a maximum thickness between the inner diameter and the outer diameter is taken along a direction between the first axis and the second axis, the direction being angled 45 degrees relative to the first axis or second axis.

28. The hinge module of claim 27, further comprising:
a shaft defining a pivot axis, wherein the torque element frictionally engages the shaft;
a housing defining a slot configured to receive at least a portion of the base portion of the torque element, the base portion comprising a bottom long side and a top flat surface opposite the bottom long side;
wherein the slot includes a plurality of ridges and grooves extending parallel to the pivot axis;
wherein the plurality of ridges and grooves form internal contact surfaces between the housing and at least a portion of the base portion of the torque element, the contact surfaces comprising (i) ridge contact surfaces between the housing and the bottom long side of the base portion of the torque element, (ii) periphery contact surfaces between the housing and the top flat surface of the base portion of the torque element, and (iii) slot contact surfaces between the housing and the base portion, excluding the ridge contact surfaces and the periphery contact surfaces; and
wherein the ridge contact surfaces and the periphery contact surfaces each define respective minimum draft angles, the respective minimum draft angles each being less than respective draft angles defined by the slot contact surfaces.

29. The hinge module of claim 27, wherein the curved arm of the torque element comprises a sickle shape.

30. The hinge module of claim 27, wherein the curved arm of the torque element comprises an omega shape.

31. The hinge module of claim 28, wherein the housing further comprises a rear wall and an end cap, wherein the side wall, the rear wall, and the end cap together define an interior space within the housing, the interior space being configured to receive the torque element inside the housing.

32. The hinge module of claim 28, wherein the plurality of ridges and grooves extend along an entirety of a length of the interior space of the housing.

33. The hinge module of claim 28, wherein the slot is defined by a plurality of straight edges and corner regions.

34. The hinge module of claim 28, wherein the slot has a perimeter, at least a portion of which is larger than a perimeter of the base portion of the torque element, such that when the hinge module is assembled, the slot is adapted for press fit engagement with at least a portion of the base portion of the torque element, thereby securing the torque element relative to the housing.

35. The hinge module of claim 31, wherein the end cap defines a first aperture and the rear wall defines a second aperture, the first aperture and the second aperture being aligned with the pivot axis of the shaft, with the shaft extending through at least the first aperture, the interior space of the housing, and the second aperture.

36. The hinge module of claim 28, wherein the housing defines a curved arm opening configured to receive at least the curved arm of the torque element.

37. The hinge module of claim 36, wherein when the hinge module is assembled, a gap formed between the curved arm opening and the torque element comprises a reservoir configured to receive a lubricant.

38. The hinge module of claim 37, wherein the lubricant includes grease.

39. The hinge module of claim 28, wherein the housing comprises a mounting surface configured to be mounted to one of the components.

40. The hinge module of claim 39, wherein the mounting surface extends downwardly relative to the pivot axis.

41. The hinge module of claim 28, further comprising an adapter configured for fixed coupling to an end portion of the shaft.

42. The hinge module of claim 41, wherein the adapter defines an opening to receive a portion of the end portion of the shaft.

43. The hinge module of claim 41, wherein the adapter includes another mounting surface configured for fixed coupling to one of the components.

44. The hinge module of claim 28, wherein the torque element defines an aperture aligned with the pivot axis of the shaft, with the shaft extending through the aperture in frictional engagement with the torque element.

45. The hinge module of claim 36, wherein a distance between a center line of the shaft and a portion of the curved arm opening is greater than another distance between a center line of the torque element to a portion of the base portion.

46. The hinge module of claim 28, wherein the housing has an interior surface, supplemental to the slot, configured to secure the torque element inside the housing and prevent the torque element from rotation relative to the housing.

47. The hinge module of claim 28, further comprising plural torque elements frictionally engaging the shaft.

48. The hinge module of claim 28, wherein the base comprises a concave recess configured to receive a center rib defined by the slot.
